(19) United States
(12) Patent Application Publication
(10) Pub. No.: US 2025/0058693 A1
(43) Pub. Date: Feb. 20, 2025

(54) INTEGRATED EXPANSION STRUCTURE WITH PNEUMATIC WALL

(71) Applicant: A&C FUTURE, INC., Newport Beach, CA (US)

(72) Inventors: Jiayang Qin, Newport Beach, CA (US); Yenchang Lin, Irvine, CA (US)

(21) Appl. No.: 18/451,356

(22) Filed: Aug. 17, 2023

(51) Int. Cl. B60P 3/34

(52) U.S. Cl. CPC B60P 3/341

(57) ABSTRACT

A foldable structure assembly includes a side expansion wall with a scissor motion system as the driving force of the expansion. The side expansion can include a flexible bellow as support of a pneumatic wall formed therewithin. An expandable floor system can be driven by the same motion system as the scissor motion system so that the floor is automatically deployed as the structure is expanded. Through those structures, the design can expand to provide about 80% more living space just in one motion, pushing out the side wall. During this motion, the wall gap will be filled by the pneumatic wall automatically and the floor gap will be filled by a part of the side wall. The expandable structure provides a simple expanding method and innovative wall structure.

### BACKGROUND OF THE INVENTION

### 1. Field of the Invention

Embodiments of the invention relate generally to expandable structures. More particularly, embodiments of the invention relate to an expandable house structure that includes a scissor motion system and a pneumatic wall.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Recently, the expandable house structure is attracting more attention both in the fields of mobile homes and recreational vehicles (RVs). The expansion mode will determine the effective living area, complexity of the driving and control system, and cost for purchase and maintenance. Exploring a concise and reliable folding/expansion mechanism is of great importance.

In view of the foregoing, there is a need for an expandable house structure that can expand living space.

### SUMMARY OF THE INVENTION

Embodiments of the present invention aim to solve the aforementioned problems in conventional expandable structures by providing a structure that permits the expansion section to extend from the main structure and to provide pneumatic walls for the front and back of the expansion section.

Embodiments of the present invention provide an expandable structure comprising a main structure having a front wall and a rear wall; an outer side wall, extending between the front wall and the rear wall, the outer side wall movable between a retracted position, adjacent the main structure, and an expanded position, away from the main structure; front and rear expansion walls interconnecting, respectively, the front wall and the rear wall of the main structure with the outer side wall; and first and second scissor structures positioned within the front wall and the rear wall, respectively, when the expandable structure is in the stowed position, wherein the first and second scissor structures are driven to move the outer side wall between the expanded and retracted positions, and in the expanded position, the first and second scissor structures extends between the outer side wall and the front and rear walls, respectively of the main structure.

Embodiments of the present invention provide an expandable structure comprising a main structure having a front wall and a rear wall; an outer side wall, extending between the front wall and the rear wall, the outer side wall movable between a retracted position, adjacent the main structure, and an expanded position, away from the main structure; and front and rear expansion walls interconnecting, respectively, the front wall and the rear wall of the main structure with the outer side wall, wherein the front and rear expansion walls are stored withing a storage area formed within respective ones of the front and rear walls; and the front and rear expansion walls each include a bellow structure encasing the scissor structure, a pneumatic structure located within the bellow structure, the pneumatic structure operable to fill with air to provide structural support for the expansion walls, and a wall skin providing an outer finish to the expansion walls.

Embodiments of the present invention provide an expandable structure comprising a main structure having a front wall and a rear wall; an outer side wall, extending between the front wall and the rear wall, the outer side wall movable between a retracted position, adjacent the main structure, and an expanded position, away from the main structure; front and rear expansion walls interconnecting, respectively, the front wall and the rear wall of the main structure with the outer side wall; first and second scissor structures positioned within the front wall and the rear wall, respectively, when the expandable structure is in the stowed position; an expansion floor section, disposed substantially vertically in the retracted position and movable to provide a floor surface for the expandable structure is in the expanded position; and a hidden floor support structure disposed within a floor of the main structure when the expandable structure is in the retracted position, the hidden floor support providing support for the expansion floor section when the expandable structure is in the expanded position, wherein the hidden floor support structure is attached to the outer side wall and moves outward from the main structure as the outer side wall moved into the expanded position; the first and second scissor structures are driven to move the outer side wall between the expanded and retracted positions; and in the expanded position, the first and second scissor structures extends between the outer side wall and the front and rear walls, respectively of the main structure.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a perspective view of an expandable structure in a completely retracted state, according to an exemplary embodiment of the present invention;

FIG. 2 illustrates a perspective view of the expandable structure of FIG. 1, in a partially opened state, where front and rear expansion walls are not shown to illustrate a scissor motion system;

FIG. 3 illustrates a perspective view of the expandable structure of FIG. 1, in the same partially opened state as FIG. 2, showing the wall structure;

FIG. 4 illustrates a perspective view of the expandable structure of FIG. 1, in a fully expanded state;

FIG. 5 illustrates a perspective view of the expandable structure of FIG. 1, in a fully expanded state, showing a final view of the front and rear expansion walls, including the wall skin disposed thereover;

FIG. 6 illustrates a cross-sectional view of the expandable structure of FIG. 1;

FIG. 7 illustrates a detailed view taken along circle 28 of FIG. 6;

FIG. 8A illustrates a side view of the expansion wall moving toward an expansion position, showing the bellows disposed about the scissor motion system;

FIG. 8B illustrates a side view of the expansion wall moving toward an expansion position, with the bellows removed to show the scissor motion system;

FIG. 9 illustrates a partially cut-away side view of the front wall of the expandable structure of FIG. 1, in a partially expanded state, with the bellows removed for visualization of the scissor motion system;

FIG. 10 illustrates a side view of the expandable structure of FIG. 1 in a partially expanded state, with the side expansion walls entirely removed for clarity;

FIG. 11 illustrates a cross-sectional view taken along line XI-XI of FIG. 10, showing the floor expansion of the expandable home of FIG. 1;

FIG. 12 illustrates a perspective view of the expandable home of FIG. 1, showing the floor movement toward its expansion position; and

FIG. 13 illustrates a geared floor movement mechanism for moving the floor member as shown in FIG. 12.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a foldable structure assembly comprising a side expansion wall with a scissor motion system as the driving force of the expansion. The side expansion can include a flexible bellow as support of a pneumatic wall formed therewithin. An expandable floor system can be driven by the same motion system as the scissor motion system so that the floor is automatically deployed as the structure is expanded. Through those structures, the design can expand to provide about 80% more living space just in one motion, pushing out the side wall. During this motion, the wall gap will be filled by the pneumatic wall automatically and the floor gap will be filled by a part of the side wall. The expandable structure provides a simple expanding method and innovative wall structure.

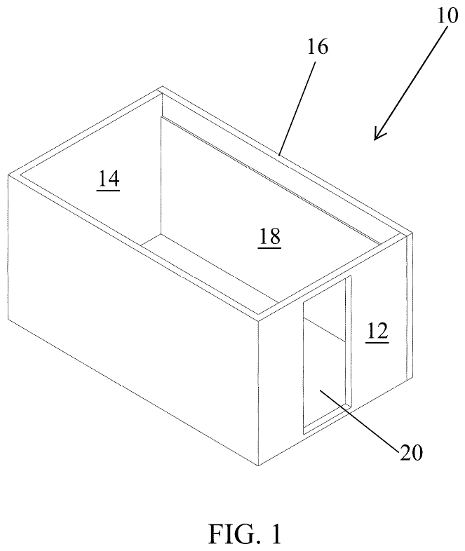

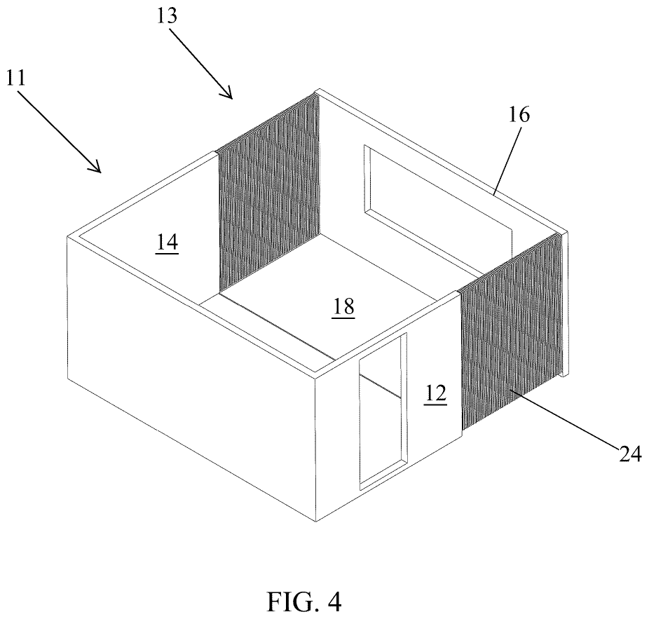

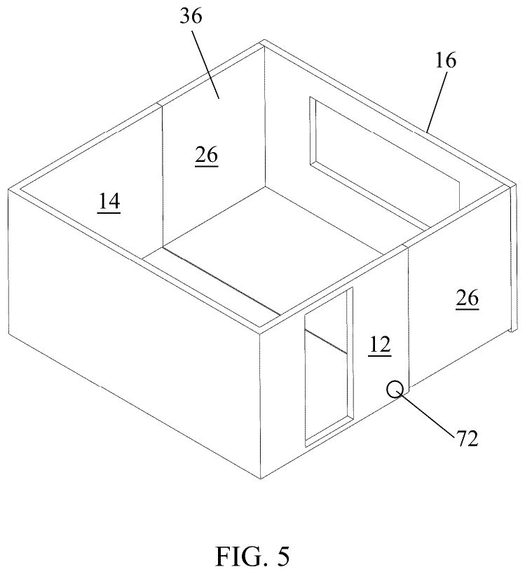

Referring to FIGS. 1 through 5, an expandable structure 10 can include a front wall 12, a back wall 14, an expandable outer wall 16 (also referred to as outer wall 16), a main section floor 20 in the main section 11 and an expansion section floor 18 for the expansion section 13. The expansion section floor 18 may be substantially vertical, as shown in FIG. 1, when the expandable structure is in the retracted state. The expansion section floor 18 may be disposed horizontally, as shown in FIGS. 4 and 5, when the expandable structure 10 is in the expanded state.

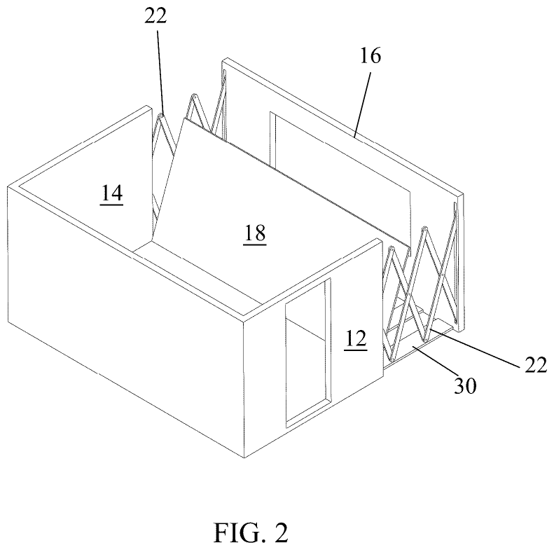

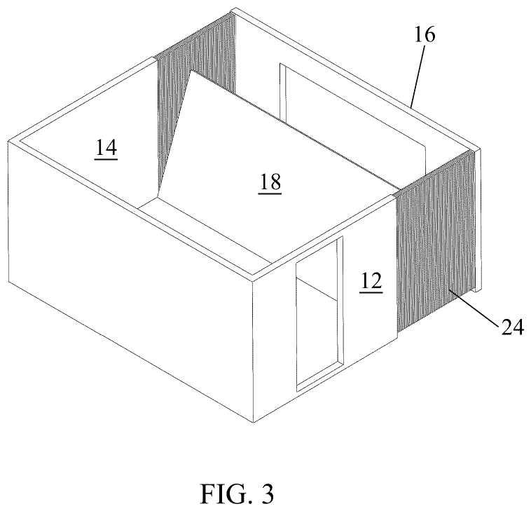

FIGS. 2 and 3 show the expandable structure partially expanded. Scissor structures 22 can be attached between the outer wall 16 and the front and rear walls 12. 14. The scissor structure 22 can serve as the driving force of the expansion of the outer wall 16 and can also deploy the bellow 24, the pneumatic structure (not shown), and the wall skin (not shown), as discussed in more detail below. All three of the bellow, the pneumatic structure and the wall skin can be pulled, altogether, with the movement of the outer wall 16.

FIG. 4 shows that, once fully expanded, part of the scissor structure remains stabilized at the hollowed part of the front and back walls 12, 14 as support and the end parts of the three layers remain latched to the previously latched parts within the front and back walls 12, 14as well as stabilization. The expansion section floor 18 can be fitted perfectly and flush with the original floor and can rest on top of the hidden frame, as further described below.

FIG. 5 shows that when the side expansion wall 26 is fully expanded, the pneumatic part (not shown) is inflated via an air pump 72 (shown in the front wall 12, but may be positioned anywhere in the expansion structure) and eventually stretched to fit the shape of the wall and seal the previous gap between the walls and floor. A wall skin 36 can cover the outer surface of the expansion walls 26 to provide a finished look thereto.

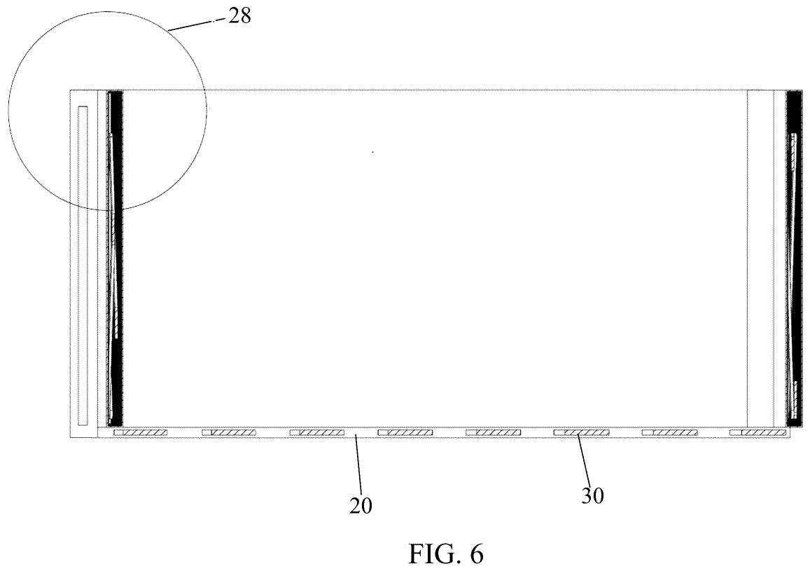

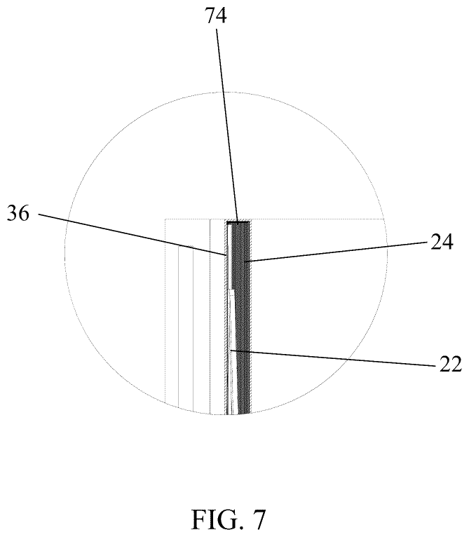

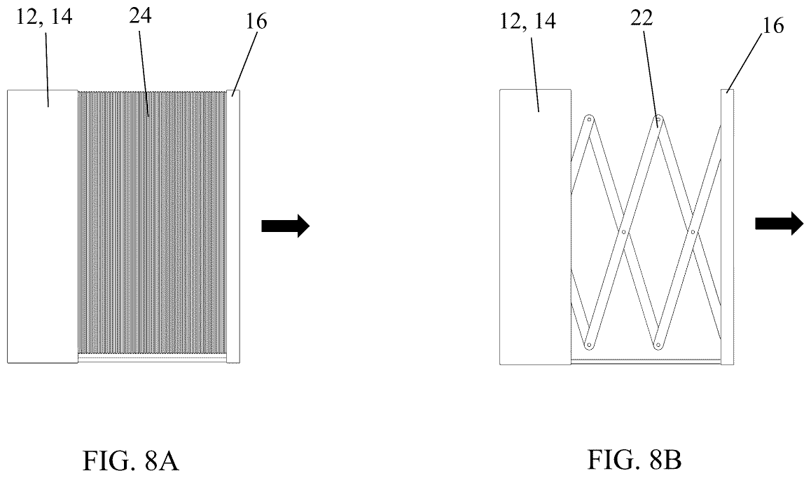

Referring now to FIGS. 6 through 9, the side expansion wall 26 can be formed of three distinct layers and the embedded scissor structure 22. When the expansion structure is in motion (such as in route to its location) and/or before its expansion, the scissor structure 22 can be folded and embedded in a space 32 (also referred to as storage area 32) within the front and back walls 12, 14. For the security of placement and resistance to motion once folded, two holes of the scissor's front bar 40 can be latched onto a path within the storage area 32, and the two holes of the back bar 52 can be latched onto the side wall.

One layer of the side expansion wall is a flexible bellow 24, originally set up in the storage area 32 of the front and back walls 12, 14. Another layer of the side expansion wall is a pneumatic structure 74 disposed in the same place as the bellow 24 and outside of the bellow 24 but closely located when compressed. Both layers can be latched onto the outer wall 16, but the pneumatic structure 74 can be latched onto the very outside of the wall, the flexible bellow 24 can be latched horizontally across from its based compressed origin. The next layer is the wall skin 36 latched to the frame and looks indistinguishable from normal wall skin. This layer can also be compressed and hidden within the front and back walls 12, 14 originally.

Thus, during expansion of the outer wall 16, the bellows 24, the pneumatic wall 74 and the wall skin 36 can be expanded to form the expansion walls 26. The pneumatic wall 74 can be pressurized with air to provide rigidity for the expansion walls 26. During retraction, the air can be removed and the expansion wall can be folded and retracted into the storage area 32.

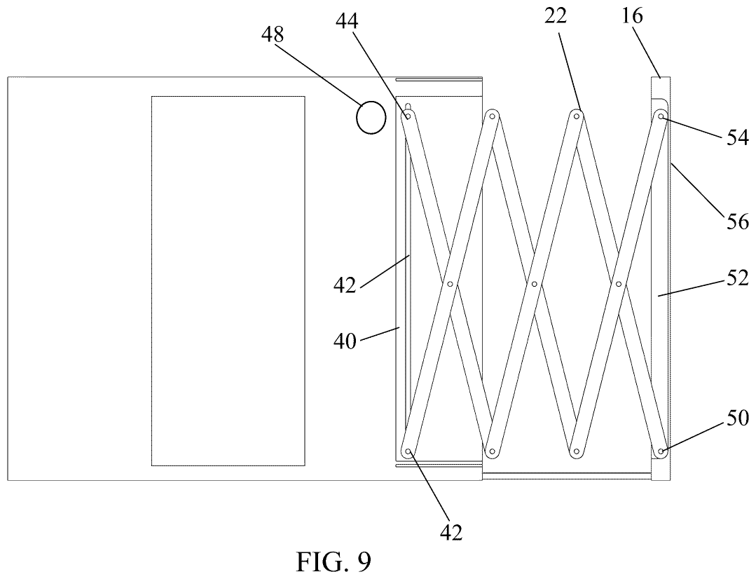

FIG. 9 shows that one end 42 of the scissor structure 22 can be fixed to the front bar 40 within the storage area 32. The other end 44 can slide along a slot 42, such as a track formed in the front bar 40. The length of the slot 42 can limit the length of extension of the scissor structure 22. The slot 42 can be equipped with an electric motor 48 as the only power output to control retraction or expansion of the scissor structure 22. Similarly, the rear bar 52 can be attached to the outer wall 16 and the scissor structure 22 can be fixed to the rear bar 52 at one end 50. The other end 54 can slide along a slot 56, such as a slot formed along the rear bar 52.

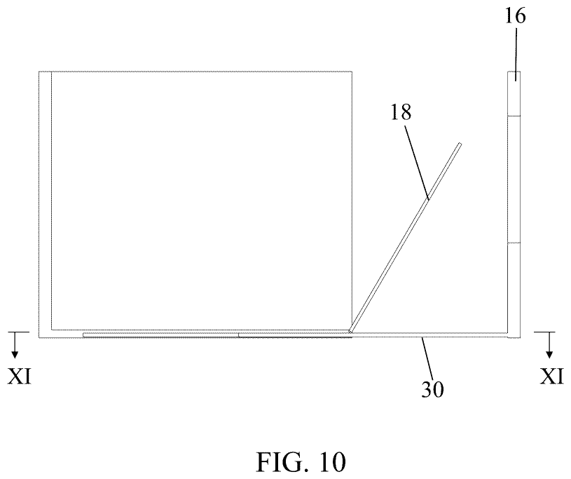

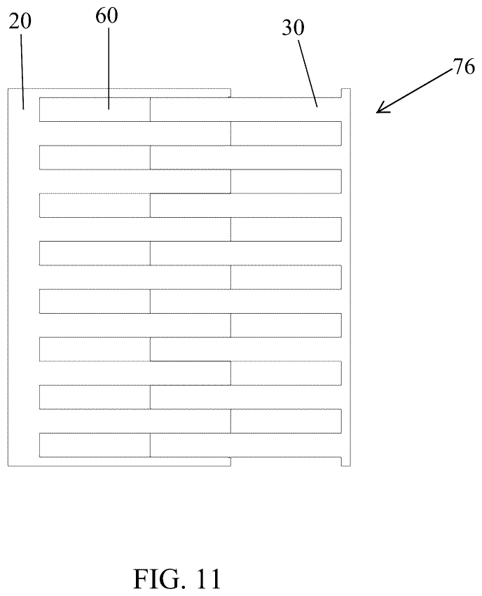

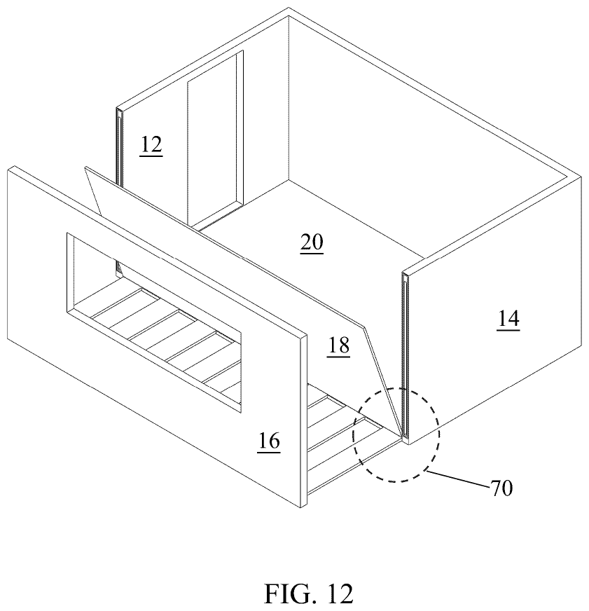

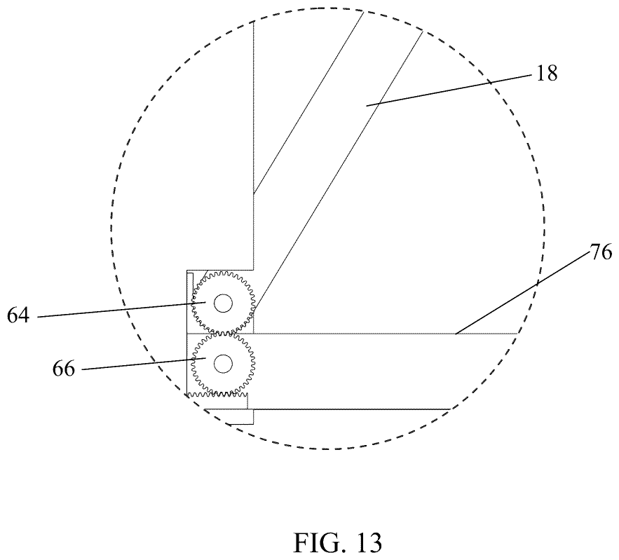

Referring now to FIGS. 10 through 13, the expansion section floor 18 can be vertical at first (when the expansion structure is retracted) and stabilized by gear set structures 64, 66. As the scissor structure 22 (see FIG. 9, for example) expands and pushes out the outer wall 16, the side expansion wall 26 pulls out a hidden frame 76 at the same time, which is can be stored within slots 60 formed in the original floor 20. In some embodiments, the hidden frame is formed from a plurality of slats 30. The expansion section floor 18 starts to fall down gradually with the rotation of the gear set 64 which is triggered by the movement of the rack 66 on the hidden frame 76.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. An expandable structure comprising:
a main structure having a front wall and a rear wall;
an outer side wall, extending between the front wall and the rear wall, the outer side wall movable between a retracted position, adjacent the main structure, and an expanded position, away from the main structure;
front and rear expansion walls interconnecting, respectively, the front wall and the rear wall of the main structure with the outer side wall; and
first and second scissor structures positioned within the front wall and the rear wall, respectively, when the expandable structure is in the stowed position, wherein
the first and second scissor structures are driven to move the outer side wall between the expanded and retracted positions,
in the expanded position, the first and second scissor structures extends between the outer side wall and the front and rear walls, respectively of the main structure.

2. The expandable structure of claim 1, wherein the front and rear expansion walls each include:
a bellow structure encasing the scissor structure;
a pneumatic structure located within the bellow structure, the pneumatic structure operable to fill with air to provide structural support for the expansion walls; and
a wall skin providing an outer finish to the expansion walls.

3. The expandable structure of claim 2, further comprising an air pump provided within the expandable structure, the air pump operable to provide air into the pneumatic structure.

4. The expandable structure of claim 2, wherein the bellows, pneumatic structure and wall skin are latched to the outer side wall to automatically deploy the front and rear expansion walls during expansion of the outer side wall.

5. The expandable structure of claim 2, wherein the pneumatic structure provides a seal between an expansion floor member and the front and rear expansion walls with the expandable structure is in the expanded position and the pneumatic structure is filled with air.

6. The expandable structure of claim 1, wherein the front and rear expansion walls are stored withing a storage area formed within respective ones of the front and rear walls.

7. The expandable structure of claim 1, further comprising an expansion floor section, disposed substantially vertically in the retracted position and movable to provide a floor surface for the expandable structure is in the expanded position.

8. The expandable structure of claim 7, further comprising a hidden floor support structure disposed within a floor of the main structure when the expandable structure is in the retracted position, the hidden floor support providing support for the expansion floor section when the expandable structure is in the expanded position.

9. The expandable structure of claim 8, wherein the hidden floor support structure is attached to the outer side wall and moves outward from the main structure as the outer side wall moved into the expanded position.

10. The expandable structure of claim 8, wherein the hidden floor support includes a plurality of slats fitting into and extendable out of slots formed in the floor of the main structure.

11. The expandable structure of claim 8, further comprising a gear structure interconnecting the expansion floor section with the hidden floor support structure, wherein movement of the hidden floor support structure automatically drives rotation of the expansion floor section to move between the expanded position and the retracted position.

12. An expandable structure comprising:
a main structure having a front wall and a rear wall;
an outer side wall, extending between the front wall and the rear wall, the outer side wall movable between a retracted position, adjacent the main structure, and an expanded position, away from the main structure; and
front and rear expansion walls interconnecting, respectively, the front wall and the rear wall of the main structure with the outer side wall, wherein:
the front and rear expansion walls are stored withing a storage area formed within respective ones of the front and rear walls; and
the front and rear expansion walls each include:
a bellow structure encasing the scissor structure;
a pneumatic structure located within the bellow structure, the pneumatic structure operable to fill with air to provide structural support for the expansion walls; and
a wall skin providing an outer finish to the expansion walls.

13. The expandable structure of claim 12, further comprising:
first and second scissor structures positioned within the front wall and the rear wall, respectively, when the expandable structure is in the stowed position, wherein:
the first and second scissor structures are driven to move the outer side wall between the expanded and retracted positions; and
in the expanded position, the first and second scissor structures extends between the outer side wall and the front and rear walls, respectively of the main structure.

14. The expandable structure of claim 12, wherein the pneumatic structure provides a seal between an expansion floor member and the front and rear expansion walls with the expandable structure is in the expanded position and the pneumatic structure is filled with air.

15. The expandable structure of claim 12, further comprising an expansion floor section, disposed substantially vertically in the retracted position and movable to provide a floor surface for the expandable structure is in the expanded position.

16. The expandable structure of claim 15, further comprising a hidden floor support structure disposed within a floor of the main structure when the expandable structure is in the retracted position, the hidden floor support providing support for the expansion floor section when the expandable structure is in the expanded position.

17. The expandable structure of claim 16, wherein the hidden floor support structure is attached to the outer side wall and moves outward from the main structure as the outer side wall moved into the expanded position.

18. The expandable structure of claim 16, wherein the hidden floor support includes a plurality of slats fitting into and extendable out of slots formed in the floor of the main structure.

19. The expandable structure of claim 16, further comprising a gear structure interconnecting the expansion floor section with the hidden floor support structure, wherein movement of the hidden floor support structure automatically drives rotation of the expansion floor section to move between the expanded position and the retracted position.

20. An expandable structure comprising:
a main structure having a front wall and a rear wall;
an outer side wall, extending between the front wall and the rear wall, the outer side wall movable between a retracted position, adjacent the main structure, and an expanded position, away from the main structure;
front and rear expansion walls interconnecting, respectively, the front wall and the rear wall of the main structure with the outer side wall;
first and second scissor structures positioned within the front wall and the rear wall, respectively, when the expandable structure is in the stowed position;
an expansion floor section, disposed substantially vertically in the retracted position and movable to provide a floor surface for the expandable structure is in the expanded position; and
a hidden floor support structure disposed within a floor of the main structure when the expandable structure is in the retracted position, the hidden floor support providing support for the expansion floor section when the expandable structure is in the expanded position, wherein:
the hidden floor support structure is attached to the outer side wall and moves outward from the main structure as the outer side wall moved into the expanded position;
the first and second scissor structures are driven to move the outer side wall between the expanded and retracted positions; and
in the expanded position, the first and second scissor structures extends between the outer side wall and the front and rear walls, respectively of the main structure.

21. The expandable structure of claim 20, wherein the front and rear expansion walls each include:
a bellow structure encasing the scissor structure;
a pneumatic structure located within the bellow structure, the pneumatic structure operable to fill with air to provide structural support for the expansion walls; and
a wall skin providing an outer finish to the expansion walls.
